(19) United States
(12) Patent Application Publication
(10) Pub. No.: US 2014/0162735 A1
(43) Pub. Date: Jun. 12, 2014

(54) CELL-PHONE CASE WITH TOUCH PEN HOLDER

(71) Applicants: Kwang J. Oh, La Crescenta, CA (US); Loren Oh, Irvine, CA (US); Austin Oh, Azusa, CA (US)

(72) Inventors: Kwang J. Oh, La Crescenta, CA (US); Loren Oh, Irvine, CA (US); Austin Oh, Azusa, CA (US)

(21) Appl. No.: 13/710,290

(22) Filed: Dec. 10, 2012

(51) Int. Cl. H04W 88/02

(52) U.S. Cl. CPC H04W 88/02
USPC 455/575.8

(57) ABSTRACT

A protective case for a mobile device includes a body, a touch-pen receiving hole, and a pen-holding device. The touch-pen receiving hole is provided through the body in a direction of length of the body. The pen-holding device is disposed at a middle portion of the touch-pen receiving hole for holding the touch pen inserted through the touch-pen receiving hole. The pen-holding device holds the touch pen in place when the touch pen is inserted through the touch-pen receiving hole and releases the touch pen when the touch pen is pushed or pulled with a force larger than a predetermined magnitude.

### BACKGROUND OF THE INVENTION

The present invention relates to a cell-phone case with touch pen holder. More particularly, this invention relates to a cell-phone case with touch pen holder, which provides means for holding touch pen and the like.

A need for a cellular phone case with touch pen holder has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a protective case for a mobile device with touch pen holder.

An aspect of the invention provides a protective case for a mobile device with touch pen holder.

A protective case for a mobile device comprises a body, a touch-pen receiving hole, and a pen-holding device.

The body is for covering the rear face of the mobile device and comprising a plurality of fastening portions configured to fasten the mobile device.

The touch-pen receiving hole is provided through the body in a direction of length of the body.

The pen-holding device is disposed at a middle portion of the touch-pen receiving hole for holding the touch pen inserted through the touch-pen receiving hole.

The pen-holding device is configured to hold the touch pen in place when the touch pen is inserted through the touch-pen receiving hole and to release the touch pen when the touch pen is pushed or pulled with a force larger than a predetermined magnitude.

The touch-pen receiving hole may have a circular cross-section.

The touch-pen receiving hole may have a diameter slightly larger than the touch pen, such that the touch pen slides in and out with substantially no friction against an inner surface of the touch-pen receiving hole without the pen-holding device.

The pen-holding device may comprise a plate spring bending convexly inward.

The plate spring may be installed on the inner surface of the touch-pen receiving hole.

The plate spring may be embedded the inner surface of the touch-pen receiving hole.

The protective case may further comprise a locking groove provided on a circumferential band portion of the touch pen.

The depth of the circumferential band portion may be determined by the predetermined magnitude of the force.

The elastic constant of the plate spring may be determined by the predetermined magnitude of the force.

The protective case may further comprise a tool-receiving hole provided through the body in a direction of length of the body for holding a predetermined tool.

The tool-receiving hole may have a rectangular cross-section.

The advantages of the present invention are: (1) the cell-phone case with touch pen holder provides an excellent way to store and retrieve the touch pen; and (2) the cell-phone case with touch pen holder according to the invention can be installed nicely with the protective case for mobile device.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a cell-phone case with touch pen holder according to an embodiment of the invention;

FIG. 2 is a cross-sectional view of the cell-phone case with touch pen holder of FIG. 1;

FIG. 3 is a partially cross-sectional perspective view of the cell-phone case with touch pen holder of FIG. 1 according to an embodiment of the invention; and

FIG. 4 is a perspective view showing a touch pen held by a holding device according to an embodiment of the invention.

### DETAILED DESCRIPTION EMBODIMENTS OF THE INVENTION

The U.S. patent application Ser. No. 13/658,742 filed on Oct. 23, 2012 by the applicant is incorporated by reference into this disclosure as if fully set forth herein.

An object of the invention is to provide a protective case for a mobile device with touch pen holder. The protective case for a mobile device was disclosed in detail in the U.S. patent application Ser. No. 13/658,742 by the applicant, in which the detailed structure of the protective case would be found.

An aspect of the invention provides a protective case 100 for a mobile device with touch pen holder.

A protective case 100 for a mobile device comprises a body 10, a touch-pen receiving hole 20, and a pen-holding device 30.

The body 10 is for covering the rear face of the mobile device and comprising a plurality of fastening portions 12 configured to fasten the mobile device.

The touch-pen receiving hole 20 is provided through the body 10 in a direction of length of the body 10.

The pen-holding device 30 is disposed at a middle portion of the touch-pen receiving hole 20 for holding the touch pen 90 inserted through the touch-pen receiving hole 20.

The pen-holding device 30 is configured to hold the touch pen 90 in place when the touch pen 90 is inserted through the touch-pen receiving hole 20 and to release the touch pen 90 when the touch pen 90 is pushed or pulled with a force larger than a predetermined magnitude.

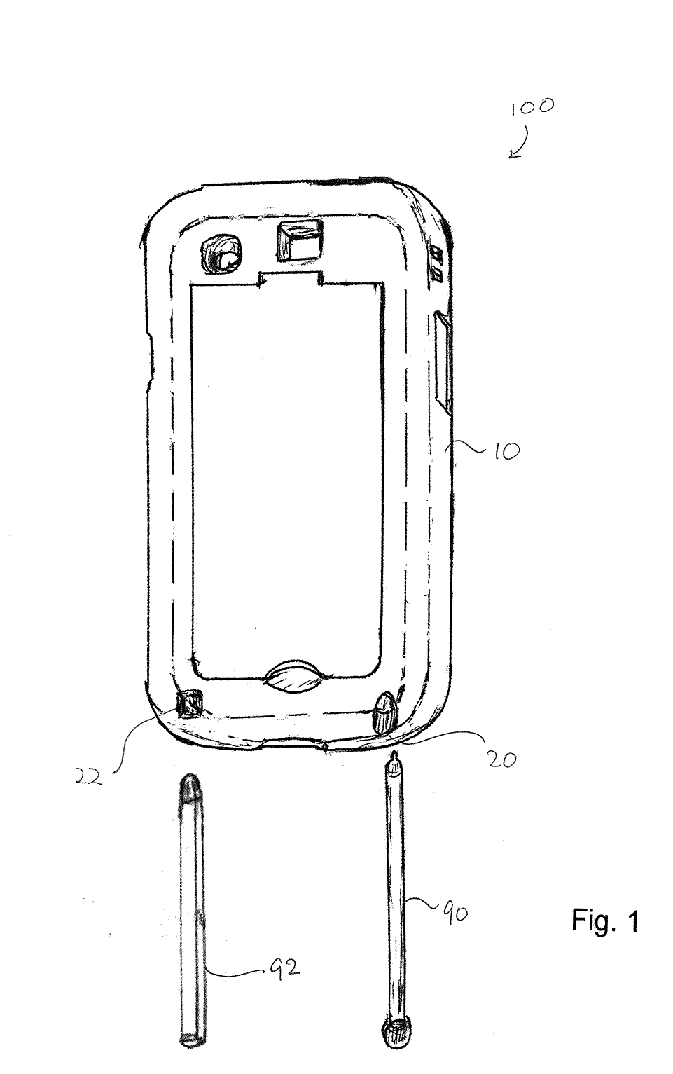

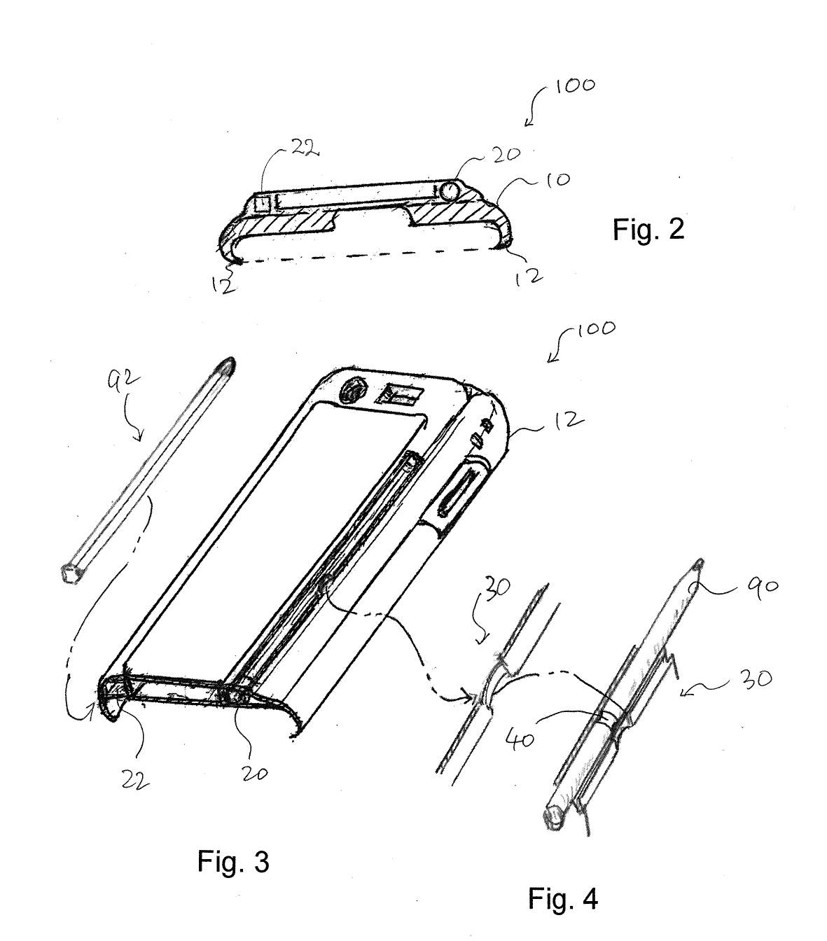

The touch-pen receiving hole 20 may have a circular cross-section as shown in FIGS. 1-3.

The touch-pen receiving hole 20 may have a diameter slightly larger than the touch pen 90, such that the touch pen 90 slides in and out with substantially no friction against an inner surface of the touch-pen receiving hole 20 without the pen-holding device 30.

The pen-holding device 30 may comprise a plate spring bending convexly inward as shown in FIG. 4.

The plate spring may be installed on the inner surface of the touch-pen receiving hole 20.

The plate spring may be embedded the inner surface of the touch-pen receiving hole 20.

The protective case 100 may further comprise a locking groove 40 provided on a circumferential band portion of the touch pen 90 as shown in FIG. 4.

The depth of the circumferential band portion 40 may be determined by the predetermined magnitude of the force.

The elastic constant of the plate spring may be determined by the predetermined magnitude of the force.

The protective case 100 may further comprise a tool-receiving hole 22 provided through the body 10 in a direction of length of the body for holding a predetermined tool 92.

The tool-receiving hole 22 may have a rectangular cross-section as shown in FIGS. 1-3.

In certain embodiments, the touch-pen holding device 30 may be applied to the tool-receiving hole 22, and the locking groove 40 provided on a circumferential band portion of the touch pen 90 may be applied to the tool 92.

Also, the touch-pen receiving hole 20 may receive a touch pen, which may be sharp or round in a tip. Also, the tool-receiving hole 22 may receive a tool, which may be sharp or round in a tip.

In certain embodiment, the depth of the touch-pen receiving hole 20 may be adjusted such that an end of the touch pen 90 can be grabbed and pulled by fingertips of the user.

Also, in certain embodiment, the pen-holding device 30 may be configured so as to pop out when the end portion is pushed in by the user.

The present invention may be provided to be added in function to the protective case disclosed in the U.S. patent application Ser. No. 13/658,742 filed on Oct. 23, 2012 by the applicant.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A protective case for a mobile device comprising:
a body for covering the rear face of the mobile device and comprising a plurality of fastening portions configured to fasten the mobile device;
a touch-pen receiving hole provided through the body in a direction of length of the body; and
a pen-holding device disposed at a middle portion of the touch-pen receiving hole for holding the touch pen inserted through the touch-pen receiving hole,
wherein the pen-holding device is configured to hold the touch pen in place when the touch pen is inserted through the touch-pen receiving hole and to release the touch pen when the touch pen is pushed or pulled with a force larger than a predetermined magnitude.

2. The protective case of claim 1, wherein the touch-pen receiving hole has a circular cross-section.

3. The protective case of claim 2, wherein the touch-pen receiving hole has a diameter slightly larger than the touch pen, such that the touch pen slides in and out with substantially no friction against an inner surface of the touch-pen receiving hole without the pen-holding device.

4. The protective case of claim 1, wherein the pen-holding device comprises a plate spring bending convexly inward.

5. The protective case of claim 4, wherein the plate spring is installed on the inner surface of the touch-pen receiving hole.

6. The protective case of claim 4, wherein the plate spring is embedded the inner surface of the touch-pen receiving hole.

7. The protective case of claim 4, further comprising a locking groove provided on a circumferential band portion of the touch pen.

8. The protective case of claim 7, wherein the depth of the circumferential band portion is determined by the predetermined magnitude of the force.

9. The protective case of claim 8, wherein the elastic constant of the plate spring is determined by the predetermined magnitude of the force.

10. The protective case of claim 1, further comprising a tool-receiving hole provided through the body in a direction of length of the body for holding a predetermined tool.

11. The protective case of claim 10, wherein tool-receiving hole has a rectangular cross-section.
